(19) United States
(12) Patent Application Publication
(10) Pub. No.: US 2024/0412007 A1
(43) Pub. Date: Dec. 12, 2024

(54) SENTENCE GENERATION DEVICE, SENTENCE GENERATION METHOD, AND RECORDING MEDIUM

(71) Applicant: NEC Corporation, Tokyo (JP)

(72) Inventors: Hiromichi Umano, Tokyo (JP); Chisato Egawa, Tokyo (JP)

(73) Assignee: NEC Corporation, Tokyo (JP)

(21) Appl. No.: 18/668,506

(22) Filed: May 20, 2024

(30) Foreign Application Priority Data
Jun. 12, 2023 (JP) 2023-096105

(51) Int. Cl. G06F 40/40; B61L 15/00

(52) U.S. Cl. CPC G06F 40/40; B61L 15/0018; B61L 15/0081

(57) ABSTRACT

A sentence generation device of the present disclosure includes an operation information acquisition means acquiring operation information after a change of transport equipment, a management means managing the operation information for each unique number of the transport equipment, and a generation means generating a sentence for notifying the operation information for each attribute of an authorized person relevant to an operation of the transport equipment with a unique number.

This application is based upon and claims the benefit of priority from Japanese Patent Application No. 2023-096105, filed on Jun. 12, 2023, the disclosure of which is incorporated herein in its entirety by reference.

### TECHNICAL FIELD

The present disclosure relates to a sentence generation device, a sentence generation method, and a recording medium.

### BACKGROUND ART

There is a technology for issuing an instruction to each attendant when a vehicle operation failure occurs. For example, JP 2003-072554 A discloses that when a train schedule is disrupted due to an accident, a failure, or the like, a train conduct arrangement plan for changing or correcting the train schedule is transmitted to a station attendant, a train conductor, and a conductor in order to perform a safe operation. JP 2011-063213 A discloses an operation information distribution device and an operation information distribution method capable of automatically instructing appropriate work contents to each attendant when a vehicle operation failure occurs.

An object of the present invention is to efficiently generate a sentence for notifying each authorized person of changed operation information.

### SUMMARY

A sentence generation device in one aspect of the present disclosure includes an operation information acquisition means acquiring operation information after a change of transport equipment, a management means managing the operation information for each unique number of the transport equipment, and a generation means generating a sentence for notifying the operation information for each attribute of an authorized person relevant to an operation of the transport equipment with a unique number.

A sentence generation method in one aspect of the present disclosure allows a computer to acquire operation information after a change of transport equipment, manage the operation information for each unique number of the transport equipment, and generate a sentence for notifying the operation information for each attribute of an authorized person relevant to an operation of the transport equipment with a unique number.

A program in one aspect of the present disclosure allows a computer to execute acquiring operation information after a change of transport equipment, managing the operation information for each unique number of the transport equipment, and generating a sentence for notifying the operation information for each attribute of an authorized person relevant to an operation of the transport equipment with a unique number.

### BRIEF DESCRIPTION OF THE DRAWINGS

Exemplary features and advantages of the present disclosure will become apparent from the following detailed description when taken with the accompanying drawings in which:

FIG. 1 is a block diagram of a configuration including a sentence generation device in the present disclosure;

FIG. 2 is a diagram illustrating a hardware configuration in which the sentence generation device in the present disclosure is enabled by a computer device and peripheral devices of the computer device;

FIG. 3 is an example of managing operation information in the present disclosure;

FIG. 4 is another example of managing the operation information in the present disclosure;

FIG. 5 is the other example of managing the operation information in the present disclosure;

FIG. 6 is an example of generating a sentence for notifying operation information of a rail vehicle in the present disclosure;

FIG. 7 is an example of generating the sentence for notifying the operation information of the rail vehicle in the present disclosure;

FIG. 8 is an example of generating the sentence for notifying the operation information of the rail vehicle in the present disclosure;

FIG. 9 is a flowchart illustrating an outline of an operation of the sentence generation device in the present disclosure;

FIG. 10 is a block diagram including a configuration of the sentence generation device in the present disclosure;

FIG. 11 is a flowchart illustrating the outline of the operation of the sentence generation device in the present disclosure;

FIG. 12 is a block diagram including the configuration of the sentence generation device in the present disclosure;

FIG. 13 is an example of a sentence for notifying schedule information generated by a second generation unit in the present disclosure; and

FIG. 14 is a flowchart illustrating the outline of the operation of the sentence generation device in the present disclosure.

### EXAMPLE EMBODIMENT

### First Example Embodiment

Hereinafter, an example embodiment of the present disclosure will be described with reference to the drawings. However, the example embodiment is not limited to the description of the drawings.

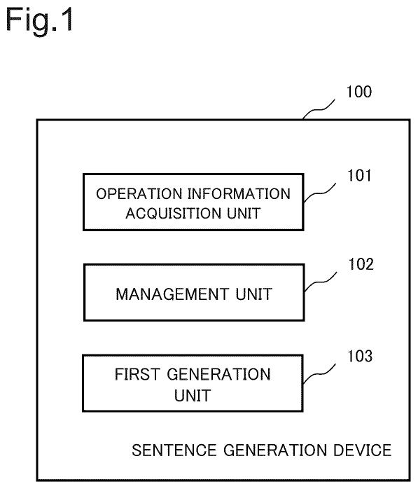

FIG. 1 is a block diagram including the configuration of a sentence generation device 100 in a first example embodiment. The sentence generation device 100 is used to generate a sentence for notifying each authorized person of transport equipment of changed operation information when such as an operation failure occurs in the transport equipment and an operation schedule is required to be changed. As illustrated in FIG. 1, the sentence generation device 100 includes an operation information acquisition unit 101, a management unit 102, and a first generation unit 103.

In the present example embodiment, a case where the transport equipment is mainly a rail vehicle will be described as an example, but the present disclosure is not limited to the rail vehicle, and can be applied to public transportation operated in accordance with a predetermined operation schedule, such as a bus, a ship, and an aircraft.

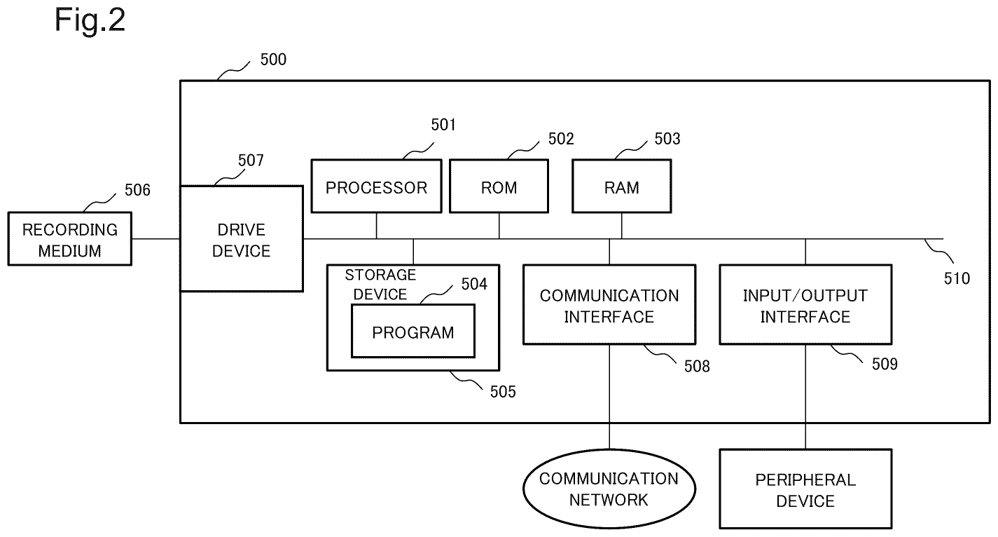

FIG. 2 is a diagram illustrating an example of a hardware configuration in which the sentence generation device 100 of the present disclosure is enabled by a computer device 500 including a processor. As illustrated in FIG. 2, the sentence generation device 100 includes a processor 501, a memory such as a read only memory (ROM) 502 and a random access memory (RAM) 503, a storage device 505 such as a hard disk that stores a program 504, a communication interface 508 for network connection, and an input/output interface 509 that inputs and outputs data. The processor 501 controls the entire computer device 500. As the processor 501, for example, a central processing unit (CPU), a digital signal processor (DSP), a graphics processing unit (GPU), a micro processing unit (MPU), a floating point number processing unit (FPU), a physics processing unit (PPU), a tensor processing unit (TPU), a quantum processor, a microcontroller, or a combination of the above can be used. In the first example embodiment, the sentence generation device 100 is connected to each constituent via a bus 510. The sentence generation device 100 illustrated in FIG. 1 can also be configured by cloud computing or the like.

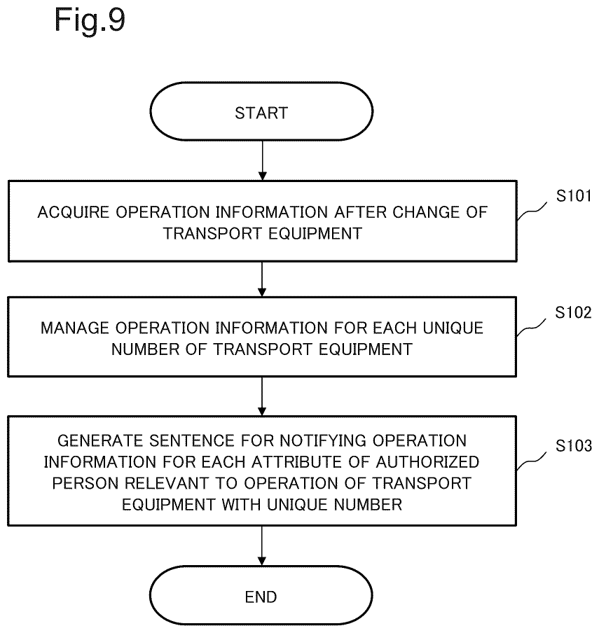

The processor 501 controls the entire sentence generation device 100 according to the present disclosure by operating an operating system. The processor 501, for example, may read out a program or data into a memory from a recording medium 506 installed in a drive device 507 or the like. The processor 501 functions as the operation information acquisition unit 101, the management unit 102, and the first generation unit 103 in the sentence generation device 100, and a part of the above, and executes processing or a command in a flowchart illustrated in FIG. 9 described below based on the program.

The recording medium 506 is, for example, an optical disk, a flexible disk, a magnetooptical disk, an external hard disk, a semiconductor memory, or the like. A semiconductor memory or the like which is a part of the recording medium is a non-volatile storage device, and records a program in the memory. The program may be downloaded from an external computer (not illustrated) connected to a communication network.

As described above, the first example embodiment illustrated in FIG. 1 is enabled by computer hardware illustrated in FIG. 2. However, a means for enabling each unit included in the sentence generation device 100 in FIG. 1 is not limited to the configuration described above. The sentence generation device 100 may be enabled by one physically coupled device, or may be enabled by a system including a plurality of devices that two or more physically separated devices are connected in a wired or wireless manner.

The operation information acquisition unit 101 is a means for acquiring operation information after a change of the transport equipment. The operation information includes, for example, an operation schedule and a maintenance work schedule of each transport equipment that is operated in any operation section. For example, when the transport equipment is a rail vehicle, the operation information includes information such as a vehicle number, a train number, a departure station, an arrival station, a departure time, an arrival time, a train conductor name, a time zone of maintenance work, an implementation place of maintenance work, and a worker name of maintenance work of the rail vehicle. The operation information acquisition unit 101 may acquire information representing operation information of a plurality of transport equipments in a diagram format for each operation section.

The changed operation information is operation information changed from the operation schedule set in advance due to an operation failure of the transport equipment or the like. The changed operation information may be information obtained using a known artificial intelligence (AI) simulator technology. For example, the AI simulator receives operation information such as a departure station, an arrival station, a departure time, an arrival time, a vehicle number, and a train conductor name before a change of the rail vehicle, and the inputs of a change portion with respect to the operation information. The change portion may be, for example, a part or all of specific rail vehicles, or may be rail vehicles within a predetermined range. Then, the AI simulator outputs a departure station, an arrival station, a departure time, an arrival time, a vehicle number, a train conductor name, and the like after the change. Such an AI simulator uses, for example, an algorithm obtained by learning using an evaluation function in which evaluation is higher as a state is closer to a state set as a target state of the rail vehicle during a normal operation. The operation information acquisition unit 101 acquires, for example, the changed operation information from the AI simulator including a device different from the sentence generation device 100.

The management unit 102 is a means for managing the operation information for each unique number of the transport equipment. For example, the management unit 102 stores the changed operation information in the storage device 505 in association with each unique number of the transport equipment. In the present example embodiment, when the transport equipment is a rail vehicle, the unique number is a vehicle number, and is a unique symbol or number assigned to each vehicle.

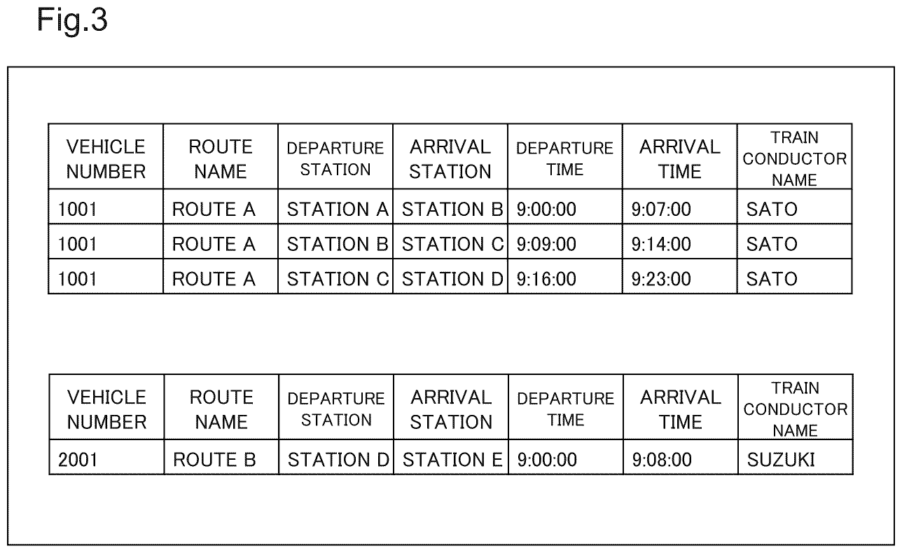

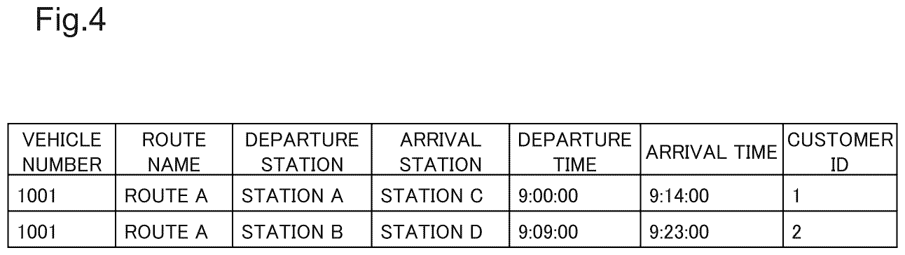

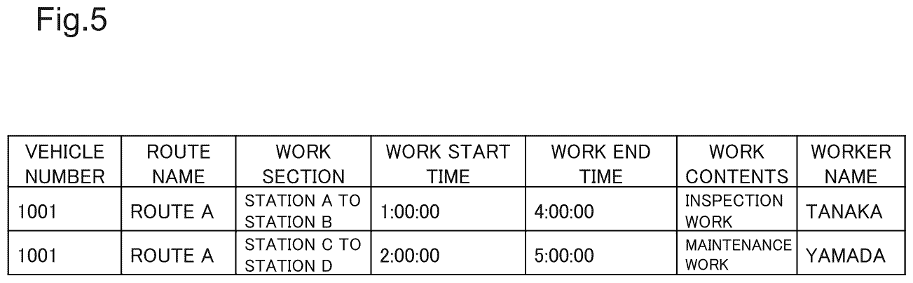

FIG. 3 is an example of managing the operation information in the present disclosure. As illustrated in FIG. 3, operation information of vehicle numbers “1001” and “2001” is managed in a separate table. FIGS. 4 and 5 are another example of managing the operation information in the present disclosure. In the example of FIG. 4, a route name, a departure station, an arrival station, a departure time, and an arrival time of each passenger boarding the vehicle number “1001” are managed. In the example of FIG. 5, the vehicle number “1001”, a route name, a work section, a work start time, a work end time, work contents, and a worker name are managed. As illustrated in FIGS. 4 and 5, the management unit 102 may manage the operation information in association with each attribute of an authorized person relevant to the operation of the transport equipment, in addition to the unique number of the transport equipment. The authorized person is a person who is relevant to the operation of the transport equipment in some way. The attribute of the authorized person is classified, for example, in accordance with a position relevant to the operation of the transport equipment, and specifically, includes a train conductor who conducts the transport equipment, a manager who manages the operation of the transport equipment, a maintenance worker who performs the maintenance work of the transport equipment, a security officer who guides a person or a car against congestion due to an operation failure of the transport equipment, a person in charge of an emergency vehicle associated to a trouble due to an operation failure, and a passenger scheduled to board the transport equipment. In a case where the transport equipment is a rail vehicle, the authorized person may include a worker of another railway company or bus company used as transfer transport of the rail vehicle with the vehicle number, a worker of a medical institution around the station, a manager of a vehicle yard, and the like.

The first generation unit 103 is a means for generating a sentence for notifying the operation information for each attribute of the authorized person relevant to the operation of the transport equipment with a unique number. The first generation unit 103 extracts notification information to be notified from the operation information for each attribute of the authorized person, and generates a sentence including the extracted notification information. The first generation unit 103 extracts the notification information that is required to be notified for each attribute of the authorized person.

For example, the first generation unit 103 extracts the vehicle number, the departure station, the arrival station, the departure time, and the arrival time of the rail vehicle to be conducted as the notification information for the train conductor of the rail vehicle, and generates a sentence with contents for notifying the above. The first generation unit 103 extracts the train number, the departure station, the arrival station, the departure time, and the arrival time of the rail vehicle for the passenger of the rail vehicle, and generates a sentence with contents for notifying the above. The first generation unit 103 extracts the vehicle number, the work place, and the work contents of the rail vehicle to be worked for the maintenance worker of the rail vehicle, and generates a sentence for notifying such contents.

In the present example embodiment, a format prepared for each attribute of the authorized person is stored in the storage device 505, and the first generation unit 103 may generate a notification sentence by inserting the notification information extracted in accordance with the format. The first generation unit 103 may generate the sentence including the notification information using a learning model generated by performing additional learning a correlation between the notification information and the sentence including the notification information based on a learned language model.

Here, the language model will be described in detail. The language model is a machine learning model trained to generate text based on an input text. More specifically, the language model is a model that is obtained by learning a relationship between words in a sentence and generates a related character string relevant to a target character string from the target character string. By using the language model obtained by learning phrases or sentences in various contexts, it is possible to generate the related character string with appropriate contents relevant to the target character string.

For example, a case where the language model is used in question and answering will be described. The language model receives the input of a question “What kind of country is Japan?” as the target character string. The language model generates a character string such as “Japan is an island country in the Northern Hemisphere . . . ” as an answer to the question.

A learning method of the language model is not particularly limited, but as an example, the language model may be learned to output at least one phrase including an input character string. As a specific example, the language model is generative pre-training (GPT) that outputs a phrase including the input character string by predicting a character string with a high probability of following the input character string. For example, a text-to-text transfer transformer (T5), bidirectional encoder representations from transformers (BERT), robustly optimized BERT approach (ROBERTa), and efficiently learning an encoder that classifies token replacements accurately (ELECTRA) are also language models.

The character string generated by the language model is not limited to a natural language. The language model, for example, may output an artificial language (such as a program source code) for a character string input in a natural language. For example, the language model receives the input of a question “How to acquire data including a specific character string from a database?” as the target character string. The language model may output a program source code for performing database processing. Alternatively, the language model may output a natural language associated to a character string input in an artificial language.

The contents generated by the language model are not limited to the character string. The language model may generate, for example, image data, video data, audio data, or other data formats associated to the input character string.

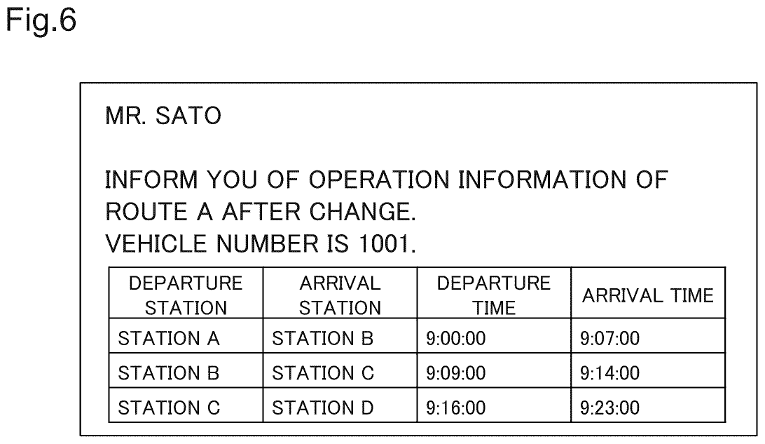

Here, an example of generating the sentence for notifying the operation information of the rail vehicle will be described using the drawings. FIGS. 6 to 8 are examples of generating the sentence for notifying the operation information of the rail vehicle in the present disclosure. The example of FIG. 6 is a sentence to be notified to the train conductor. As illustrated in FIG. 6, the sentence generated by the first generation unit 103 includes a sentence including the departure time and the arrival time at each station, in addition to the vehicle number of the rail vehicle conducted by the train conductor. In the example of FIG. 6, the departure station, the arrival station, the departure time, and the arrival time are illustrated in a table. The sentence generated by the first generation unit 103 may include a map or a graph in addition to the table.

An example of a method for the first generation unit 103 to generate the sentence using the language model will be described. The first generation unit 103 generates a character string (also referred to as a “prompt”) to be input to the language model based on the extracted notification information.

The first generation unit 103 may generate the prompt based on the generated information. For example, a case where the first generation unit 103 extracts a vehicle number, a departure station, an arrival station, a departure time, and an arrival time of a rail vehicle conducted by a train conductor A as the notification information and generates the notification sentence for the train conductor A of the rail vehicle will be described as an example. In such a case, the first generation unit 103 generates the following prompt.

### (Prompt)

Please create a sentence for notifying train conductor A of the following contents.
Departure Station: ○○ Station, Arrival Station: ○○ Station, Departure Time: ○○ Station, Arrival Time: ○○ Station

The first generation unit 103 is capable of inputting the above prompt to the language model and generating the sentence as illustrated in FIG. 6. The above prompt may be different in accordance with the destination of the notification sentence or the data extracted by the first generation unit 103. For example, the first generation unit 103 is capable of using a fixed phrase set in advance for each authorized person as the prompt.

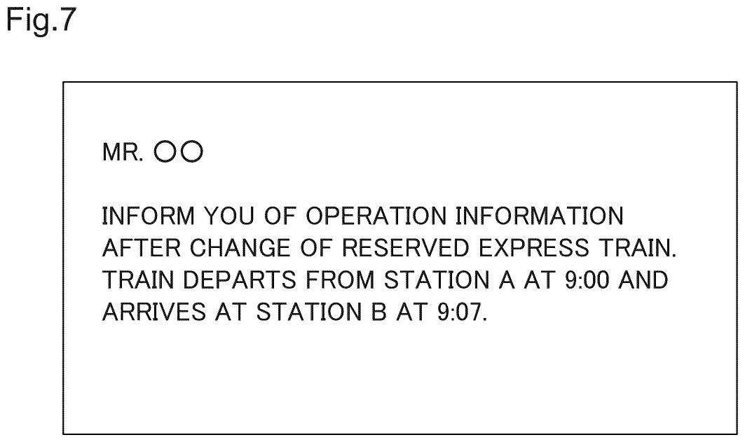

The example of FIG. 7 is a sentence to be notified to the passenger of the rail vehicle. As illustrated in FIG. 7, the sentence generated by the first generation unit 103 includes, for example, a train number, a departure station, a departure time, an arrival station, and an arrival time of a rail vehicle to be boarded. In a case where the rail vehicle to be boarded is suspended, the first generation unit 103 may generate a sentence for notifying such contents.

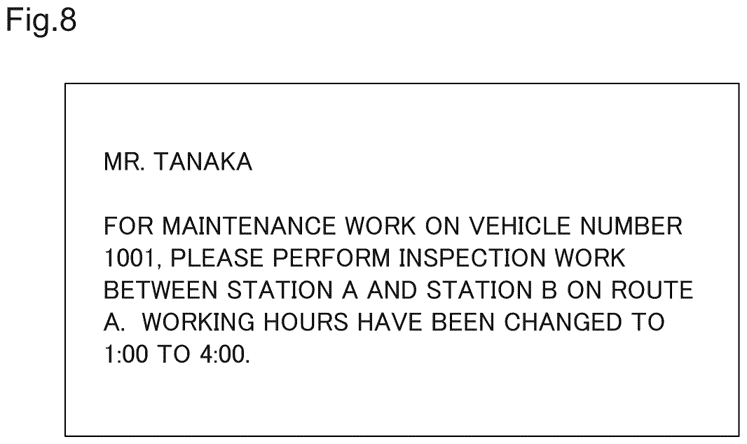

The example of FIG. 8 is a sentence to be notified to the maintenance worker. As illustrated in FIG. 8, the sentence generated by the first generation unit 103 includes, for example, a vehicle number of a maintenance work target, a work section, work contents, a work start time, and a work end time. As illustrated in FIG. 8, the first generation unit 103 may generate a sentence in which a change point can be grasped from scheduled work contents.

FIG. 9 is a flowchart illustrating the outline of the operation of the sentence generation device 100 in the present disclosure. The processing according to this flowchart may be executed based on program control by the processor described above.

As illustrated in FIG. 9, first, the operation information acquisition unit 101 acquires the operation information after the change of the transport equipment (step S101). Next, the management unit 102 manages the operation information for each unique number of the transport equipment (step S102). Finally, the first generation unit 103 generates the sentence for notifying the operation information for each attribute of the authorized person relevant to the operation of the transport equipment with the unique number (step S103). As described above, the sentence generation device 100 ends the sentence generation processing.

In the sentence generation device 100 according to the present example embodiment, the management unit 102 manages the operation information for each unique number of the transport equipment. Then, the first generation unit 103 generates the sentence for notifying the operation information for each attribute of the authorized person relevant to the operation of the transport equipment with the unique number. As a result, it is possible to efficiently generate the sentence for notifying each of the authorized persons of the operation information after the change without individually generating the notification sentence. Therefore, even in a case where the schedule is suddenly changed due to an accident or the like, the sentence generation device 100 according to the present example embodiment is capable of supporting rapid decision making and operation execution by the authorized person.

### First Modification Example

Next, a modification example of the first example embodiment of the present disclosure will be described focusing on a difference from the first example embodiment. Each modification example can be applied in combination. That is, a sentence generation device 120 in a second modification example described below may include an external information acquisition unit 113 in the present modification example. A sentence generation device 110 in the present modification example does not use the notification information included in the operation information as it is, but generates a sentence for notifying the operation information for each attribute of the authorized person based on the notification information and external information.

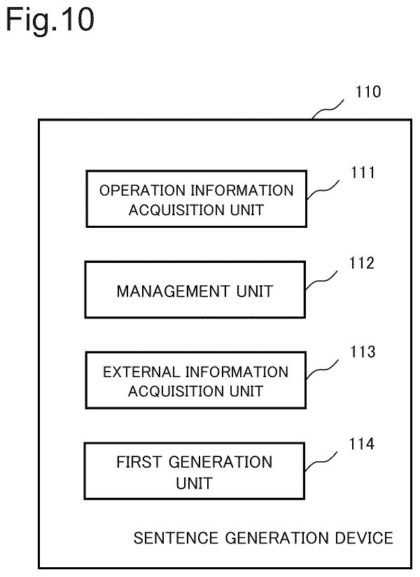

FIG. 10 is a block diagram including the configuration of the sentence generation device 110 in the present disclosure. The sentence generation device 110 includes the external information acquisition unit 113, in addition to the configuration of the sentence generation device 100. That is, the sentence generation device 110 includes an operation information acquisition unit 111, a management unit 112, the external information acquisition unit 113, and a first generation unit 114. Since the configuration of the operation information acquisition unit 111 and the management unit 112 is the same as that of the associated constituents of the first example embodiment, the detailed description of the constituents will be omitted.

The external information acquisition unit 113 is a means for acquiring the external information relevant to the notification information. The external information is, for example, information that can be acquired by anyone, such as information published on the WEB. The external information acquisition unit 113 analyzes the contents indicated by the notification information, and acquires the external information relevant to the analyzed contents.

For example, the external information acquisition unit 113 may acquire event information held in a time zone in which the rail vehicle departs or arrives at an event venue around a station based on a station name and a departure time or an arrival time. The event information may include an event start time, an event end time, visitor prediction, congestion prediction, and the like. The external information acquisition unit 113 may acquire, for example, accident information that occurred around the station a predetermined time ago. The accident information may include information indicating the situation of an accident such as an injured person. The external information acquisition unit 113 may acquire information of a weather forecast around the station. In a case where the rail vehicle is suspended or greatly delayed, the external information acquisition unit 113 may acquire information of the rail vehicle that can be boarded instead by a passenger who has been scheduled to board. The external information acquisition unit 113 may acquire a seat number of a rail vehicle to be boarded instead by a passenger who has received the designation of a seat in the rail vehicle to be boarded.

In addition to the function of the first generation unit 103, the first generation unit 114 generates a sentence for notifying the operation information for each attribute of the authorized person relevant to the operation of the transport equipment with the unique number based on the notification information and the external information. The first generation unit 114 extracts the external information that is required to be notified for each attribute of the authorized person, and generates a sentence including the extracted external information. For example, in a case where congestion is predicted due to the holding of the event, the first generation unit 114 may generate a sentence including a predicted boarding rate of the rail vehicle to be conducted for the train conductor. The first generation unit 114 may generate, for the passenger, a sentence including a predicted boarding rate of the rail vehicle to be boarded, or a predicted congestion rate around a departure station or an arrival station. The first generation unit 114 may generate a sentence for notifying the security officer of a guidance instruction around the station in a case where congestion is predicted due to the holding of the event. In a case where an accident occurs, the first generation unit 114 may generate a sentence for notifying the person in charge of the emergency vehicle or the worker of the medical institution of the situation of the accident.

In a case where the rail vehicle to be boarded by the passenger is suspended or greatly delayed, the first generation unit 114 may generate a sentence for notifying such contents, or may generate a sentence for notifying the contents of the rail vehicle to be boarded instead by the passenger. The first generation unit 114 may generate a sentence including the seat number of the rail vehicle to be boarded instead for the passenger who has received the designation of the seat of the rail vehicle. The sentence generated by the first generation unit 114 is an example, and the sentence generated by the sentence generation device 100 is not limited to the above.

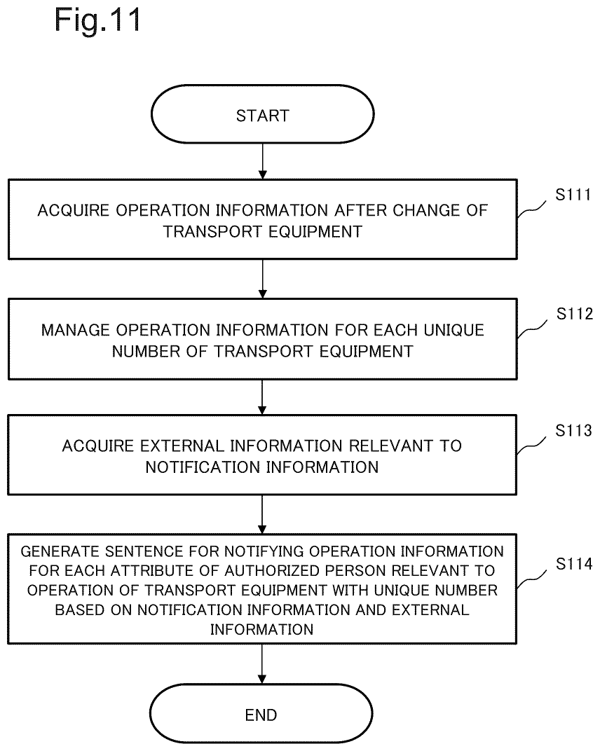

FIG. 11 is a flowchart illustrating the outline of the operation of the sentence generation device 110 in the present disclosure. The processing according to this flowchart may be executed based on program control by the processor described above.

As illustrated in FIG. 11, first, the operation information acquisition unit 111 acquires the operation information after the change of the transport equipment (step S111). Next, the management unit 112 manages the operation information for each unique number of the transport equipment (step S112). Next, the external information acquisition unit 113 acquires the external information relevant to the notification information (step S113). Finally, the first generation unit 114 generates the sentence for notifying the operation information for each attribute of the authorized person relevant to the operation of the transport equipment with the unique number based on the notification information and the external information (step S114). As described above, the sentence generation device 110 ends the sentence generation processing.

In the present modification example, the external information acquisition unit 113 acquires the external information relevant to the notification information, and the first generation unit 114 generates the sentence for notifying the operation information for each attribute of the authorized person relevant to the operation of the transport equipment with the unique number based on the notification information and the external information. Accordingly, by combining the notification information with the related external information, it is possible to provide more practical information for each authorized person.

### Second Modification Example

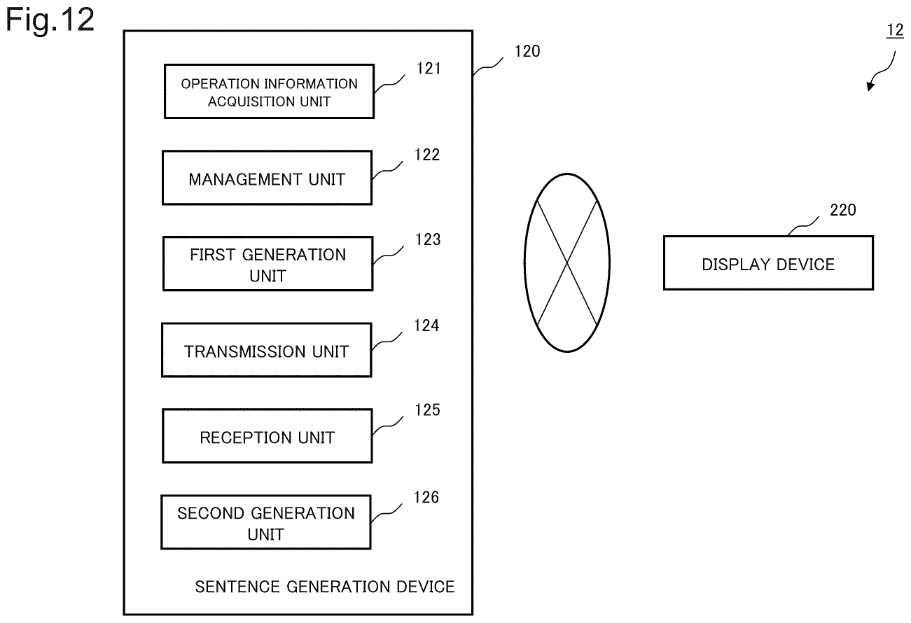

Next, another modification example of the first example embodiment of the present disclosure will be described focusing on a difference from the first example embodiment. FIG. 12 is a block diagram including the configuration of the sentence generation device 120 in the present disclosure. In the present modification example, a sentence generation system 12 including the sentence generation device 120 and a display device 220 connected to the sentence generation device 120 via a network may be configured.

The sentence generation device 120 in the present modification example transmits the sentence for notifying the operation information to the display device 220 visually recognized by the authorized person, and generates a sentence for notifying schedule information in response to a notification request for the schedule information from the display device 220 that is a transmission destination. The display device 220 may be a device used by the authorized person relevant to the operation of the transport equipment and may be a terminal possessed by each authorized person. The display device 220 may be a signage installed at a station or an event venue.

The sentence generation device 120 includes a transmission unit 124, a reception unit 125, and a second generation unit 126, in addition to the configuration of the sentence generation device 100. That is, the sentence generation device 120 includes an operation information acquisition unit 121, a management unit 122, a first generation unit 123, the transmission unit 124, the reception unit 125, and the second generation unit 126. Since the configuration of the operation information acquisition unit 121 and the first generation unit 123 is the same as that of the associated constituents of the first example embodiment, the detailed description of the constituents will be omitted.

The management unit 122 manages the operation information for each authorized person, in addition to the function of the management unit 102. The operation information in the present modification example is scheduled operation information, and includes operation information that is not changed from operation information set in advance. Each authorized person indicates each authorized person relevant to the operation of the transport equipment. The management unit 122 manages the operation information of the transport equipment in association with information for specifying each authorized person.

The transmission unit 124 is a means for transmitting the sentence generated by the first generation unit 123 to the display device 220 visually recognized by the authorized person. For example, the transmission unit 124 transmits the sentence generated for each attribute of the authorized person to contact destination registered in advance.

The reception unit 125 is a means for receiving the notification request for the schedule information from the display device 220 that is the transmission destination. The reception unit 125 receives, for example, the notification request for the schedule information input by a character or a voice to the display device 220. Upon receiving the notification request for the schedule, the reception unit 125 outputs such information to the second generation unit 126.

The second generation unit 126 generates the sentence for notifying the schedule information of the predetermined authorized person based on the operation information managed for each authorized person. The transmission unit 124 generates the sentence for notifying the schedule information of the authorized person who has received the notification request for the schedule. In the present modification example, a method for the second generation unit 126 to generate the sentence for notifying the schedule information is the same as that of the first generation unit 123. That is, the second generation unit 126 may generate the notification sentence by inserting the operation information that is required to be notified in accordance with the format prepared for each attribute of the authorized person. The second generation unit 126 may generate the sentence for notifying the schedule information by using a learning model generated by additionally learning a correlation between the operation information and the sentence for notifying the schedule information based on a learned language model. The language model is the same as the language model described above.

The transmission unit 124 transmits the sentence generated by the second generation unit 126 to the display device 220 that is a transmission source of the notification request.

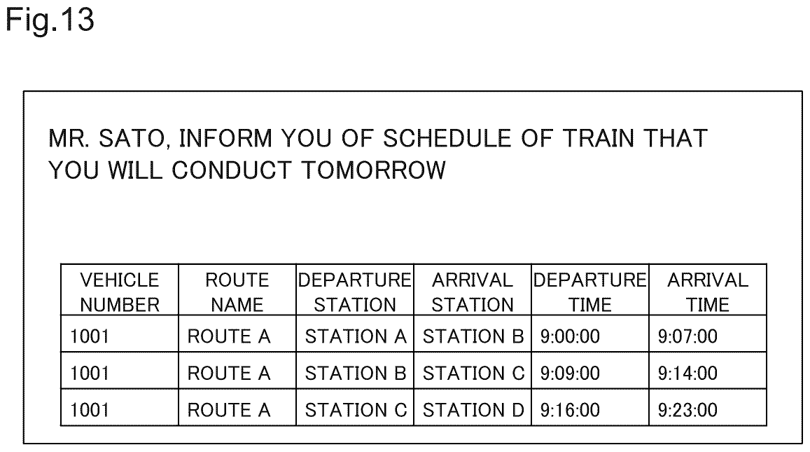

FIG. 13 is an example of the sentence for notifying the schedule information generated by the second generation unit 126 in the present disclosure. The example of FIG. 13 is a sentence of the schedule information to be notified to the train conductor. As illustrated in FIG. 13, the sentence generated by the second generation unit 126 includes a sentence including the vehicle number, and the departure time and the arrival time at each station of the rail vehicle conducted by the train conductor. In the example of FIG. 13, the vehicle number, the route name, the departure station, the arrival station, the departure time, and the arrival time are illustrated in a table, but such information may be illustrated in a sentence.

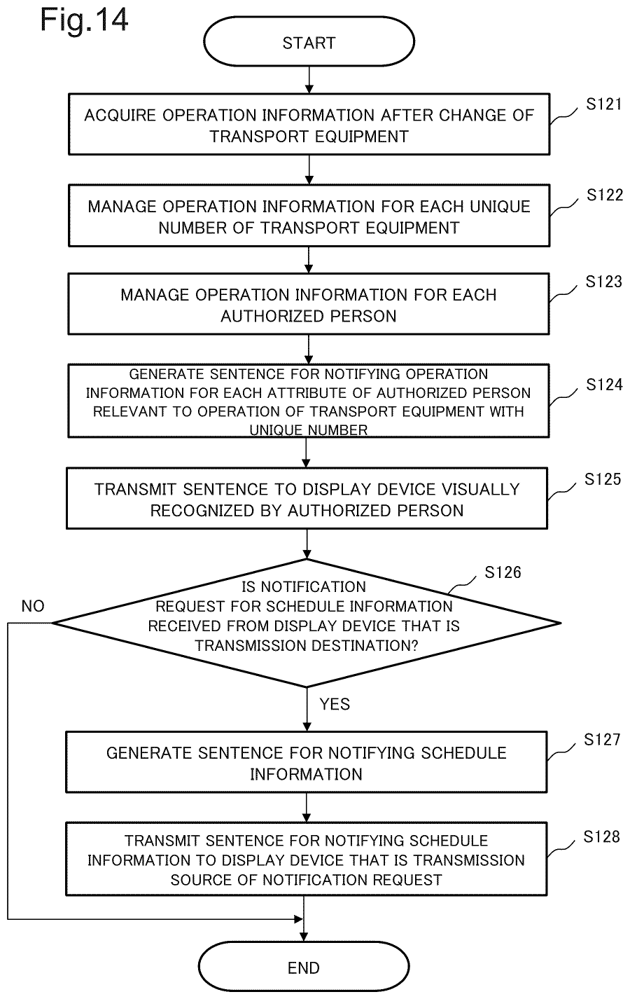

FIG. 14 is a flowchart illustrating the outline of the operation of the sentence generation device 120 in the modification example of the first example embodiment. The processing according to this flowchart may be executed based on program control by the processor described above.

As illustrated in FIG. 14, first, the operation information acquisition unit 121 acquires the operation information after the change of the transport equipment (step S121). Next, the management unit 122 manages the operation information for each unique number of the transport equipment (step S122). The management unit 122 manages the operation information for each authorized person (step S123). Next, the first generation unit 123 generates the sentence for notifying the operation information for each attribute of the authorized person relevant to the operation of the transport equipment with the unique number (step S124). Next, the transmission unit 124 transmits the sentence to the display device 220 visually recognized by the authorized person (step S125). Next, in a case where the reception unit 125 receives the notification request for the schedule information from the display device 220 that is the transmission destination (step S126; YES), the second generation unit 126 generates the sentence for notifying the schedule information (step S127). Next, the transmission unit 124 transmits the sentence for notifying the schedule information to the display device 220 that is the transmission source of the notification request (step S128). On the other hand, in a case where the notification request for the schedule is not received from the display device 220 that is the transmission destination in S126 (S126; NO), this flow is ended. As described above, the sentence generation device 120 ends the sentence generation processing.

In the sentence generation device 120 of the present modification example, the management unit 122 manages the operation information for each authorized person. Then, in a case where the reception unit 125 receives the notification request for the schedule information from the display device 220 that is the transmission destination, the second generation unit 126 generates the sentence for notifying the schedule information of the authorized person based on the operation information managed for each authorized person, and the transmission unit 124 transmits the sentence for notifying the schedule information to the display device 220. As a result, it is possible to easily notify the schedule information different for each authorized person.

Although the present disclosure has been described with reference to the example embodiment, the present invention is not limited to the example embodiment. Various modifications that can be understood by a person skilled in the art can be made to the configuration and the details of the present invention within the scope of the present invention. The present disclosure may include an example embodiment in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order of executing the plurality of operations. Therefore, when each example embodiment is implemented, the order of the plurality of operations can be changed within a range that does not interfere with the content. Specifically, in the flowchart of FIG. 14, the flow of S123 and S124 may be performed at the same timing. In the flowchart of FIG. 14, the flow of S126 may be omitted. That is, even in a case where the reception unit 125 does not receive the notification request for the schedule from the display device 220, the second generation unit 126 may generate the sentence for notifying the schedule information of each authorized person based on the operation information managed for each authorized person, and transmission unit 124 may transmit the generated sentence to the display device 220.

The invention disclosed in JP 2003-072554 A is based on the premise that the same train conduct arrangement plan is transmitted to an authorized person relevant to the operation of the train. The invention disclosed in JP 2011-063213 A is based on the premise that the work contents are instructed only to the attendant boarding the vehicle. In a case where the operation schedule of the transport equipment including the train is changed, the contents that are required to be notified differ by the position of the authorized person relevant to the operation of the transport equipment. In this case, it takes time and effort to generate the notification sentence individually for each authorized person. Therefore, there is a demand for a method for efficiently notifying each authorized person of a change of operation information.

According to the present disclosure, it is possible to efficiently generate the sentence for notifying each authorized person of the changed operation information.

1. A sentence generation device, comprising:
a memory storing instructions; and
at least one processor configured to execute the instructions to:
acquire operation information after a change of transport equipment;
manage the operation information for each unique number of the transport equipment; and
generate a sentence for notifying the operation information for each attribute of an authorized person relevant to an operation of the transport equipment with a unique number.

2. The sentence generation device according to claim 1, wherein the at least one processor is further configured to execute the instructions to:
extract notification information to be notified from the operation information for each attribute of the authorized person; and
generate the sentence including the notification information.

3. The sentence generation device according to claim 2, wherein the at least one processor is further configured to execute the instructions to:
generate the sentence using a machine learning model trained to generate a text based on an input text.

4. The sentence generation device according to claim 2, wherein the at least one processor is further configured to execute the instructions to:
acquire external information relevant to the notification information; and
generate the sentence based on the notification information and the external information.

5. The sentence generation device according to claim 1, wherein the at least one processor is further configured to execute the instructions to:
transmit the sentence to a display device visually recognized by the authorized person.

6. The sentence generation device according to claim 1, wherein the at least one processor is further configured to execute the instructions to:
manage the operation information for each of the authorized persons; and
generate a sentence for notifying schedule information of a predetermined authorized person based on the operation information managed for each of the authorized persons.

7. The sentence generation device according to claim 6, wherein the at least one processor is further configured to execute the instructions to:
transmit the sentence to a display device visually recognized by the authorized person;
receive a notification request for the schedule information from the display device that has transmitted the sentence;
generate a sentence for notifying the schedule information when receiving the notification request; and
transmit the schedule information to a display device that is a transmission source of the notification request.

8. The sentence generation device according to claim 1,
wherein the transport equipment is a rail vehicle, and
the unique number is a vehicle number of the rail vehicle.

9. A sentence generation method for allowing a computer to execute:
acquiring operation information after a change of transport equipment;
managing the operation information for each unique number of the transport equipment; and
generating a sentence for notifying the operation information for each attribute of an authorized person relevant to an operation of the transport equipment with a unique number.

10. A non-transitory computer-readable storage medium storing a program for allowing a computer to execute processing comprising:
acquiring operation information after a change of transport equipment;
managing the operation information for each unique number of the transport equipment; and
generating a sentence for notifying the operation information for each attribute of an authorized person relevant to an operation of the transport equipment with a unique number.
